(19) United States
(12) Patent Application Publication
(10) Pub. No.: US 2016/0335697 A1
(43) Pub. Date: Nov. 17, 2016

(54) COMPUTER IMPLEMENTED METHOD FOR RANKING DATA & REMOVING DEPENDENCIES ON MENUS OR MULTIPLE FIELDS AND CONTROLS

(71) Applicants: Vinay BAWRI, Ballygunge (IN); Ritesh BAWRI, Ballygunge (IN); Malvika BAWRI, Ballygunge (IN)

(72) Inventors: Vinay BAWRI, Ballygunge (IN); Ritesh BAWRI, Ballygunge (IN); Malvika BAWRI, Ballygunge (IN)

(21) Appl. No.: 15/153,253

(22) Filed: May 12, 2016

(30) Foreign Application Priority Data
May 13, 2015 (IN) 1169/KOL/2014

(51) Int. Cl. G06Q 30/06; G06F 17/30

(52) U.S. Cl. CPC G06Q 30/0629; G06F 17/30554; G06F 17/3053; G06F 17/30598

(57) ABSTRACT

The processor implemented method and system disclosed herein includes transmitting a search term to a server via a user computing device, wherein the server identifies a plurality of categories and a plurality of products corresponding to the search term. The method and system is adapted to access a plurality of weightage attributes and a plurality of ranking attributes through the server. The method and system thereafter determines a weightage level for each identified category and also determines a ranking level for each identified product. The method and system is adapted to sort the at least one category and the at least one product. The sorting is based on the plurality of weightage attributes and plurality of ranking attributes respectively. After sorting, the method is adapted to display said sorted category and sorted product through the user computing device.

### CROSS REFERENCE TO RELATED APPLICATIONS

This complete specification is filed in pursuance of the provisional Indian patent application numbered 1169/KOL/2014 filed at Indian Patent Office on 13th May, 2015.

### FIELD OF THE DISCLOSURE

The present disclosure relates generally to computer implemented method for data processing, and more particularly to computer implementable techniques for providing efficient ways of searching for product/service items, general information, and categories on a website, a web application, mobile apps, and a data repository.

### BACKGROUND OF THE DISCLOSURE

In the present internet age, most of the population around the world uses internet search engines to look for and to retrieve desired information. The information may be related to a person, a place, a specific topic, a product and the like. Today, most of the ecommerce websites, such as Amazon.com, Staples.com, Ebay.com, Linkedin.com and the like, as well as most web and mobile applications uses menus and filters to help users locate specific content. While using such websites, applications and data repositories, a user has to navigate through menus and filters to narrow down large quantity of information to find the desired information or desired product.

Today, the most commonly used systems for searching a specific query over the World Wide Web are Google search and Bing search. In Google search, the user is not required to go through menus to locate the specific information, (though Google does provide an advanced search option). This feature of Google search is very user friendly while finding the relevant information as required by the user.

As the data present on the World Wide Web and in data repositories is increasing day by day, there is a need of an intelligent system and method which can easily understand users' search query and provide only those results which are very specific to the users search query.

Some ecommerce websites such as, Amazon™, eBay™, and the like, employ algorithms to provide specific results related to users' search query. While searching on these ecommerce websites, the user has to choose a category from a drop down menu. Further, once the results are displayed, the user may have to again filter the results based on sub categories, ratings and other similar filters.

Despite major advancements in processing power and storage capacity, most ecommerce data processing systems i.e. data warehouses, data search systems do not provide an ability to determine relevant results for a search query without using any dropdown menus or filters. This limitation of not providing relevant results for a search query without the use of dropdown menus and/or filters sometimes provides search results that are not highly relevant to the users' requirement. In case the user does not select an option from the drop down menu, and searches the entire database, the user is required to do a lot of filtering to locate the specific product, service or information that the user is looking for. This can be tedious and unnecessary burdened for the user.

The technical problem in such data processing environment will be better understood by way of an example. Consider a user who desires to find and purchase a specific retail item on an ecommerce website. The user enters the input into the search box and various categories are displayed that potentially match the users search term. These categories would be the same categories which would be displayed in a drop down menu. Different methods of navigation and varying user interfaces on different websites can make the task of finding the desired result even more tedious and difficult for a user.

There have been various solutions developed in recent years for searching and ranking results derived by a search mechanism. For example, U.S. Pat. No. 7,966,309 (Yael et al.) discloses a computer implemented method for searching and ranking the search results present in multiple categories. The method includes receiving from a remote device a search query, generating a plurality of different category-directed result sets for the search query, determining an order for the plurality of category-directed result sets based on the search query, and transmitting the plurality of category-directed result sets to the remote device, in a manner that the result sets are to be displayed in the remote device in the determined order. However, the system as disclosed does not provide a means for conducting searching without using search menus. The use of menus is still an inherent part of websites.

### SUMMARY OF THE DISCLOSURE

In view of the foregoing disadvantages inherent in the prior-art and the needs as mentioned above, the general purpose of the present disclosure is to provide a better data processing methodology employed by a data processor for ranking of search results in order to provide the best/most relevant results to the user.

This disclosure proposes an intelligent system and computer implemented method of ranking and displaying specific search results on ecommerce sites and on other web portals, cloud and desktop portals, and data repositories and web search engines.

The method of the present disclosure will almost greatly decrease or completely eliminate the need to use drop down menus and filters for locating a specific product, service, topic, news item, place, etc. Moreover, the present disclosure removes the dependencies on menus/multiple fields/multiple controls in order to facilitate easier search and improves search result representation to the user on various web sites in the computing world.

Yet another object of the present disclosure is to provide a system and method for enabling better understanding of the users' search query and providing automatic filtered results without using menus or filters.

Further another object of the disclosure is to provide a better ranking methodology in which the best/most relevant results are provided at the top of the displayed results.

Present disclosure provides a system and method for removing dependencies of users on menus or multiple fields and filters or controls while searching for products, services, general or information and the like on a website, in the cloud, on a desktop, on a mobile device, or data repository. Further, the present disclosure is configured to include all advantages of the prior art and to overcome the drawbacks inherent in the prior art offering many added advantages.

The present disclosure provides a computer implemented method for identifying a product, service, information and the like in an online platform, offline platform, plug-in, cloud based platform and the like, which may include using a server connected to a database having a plurality of categories and a plurality of products corresponding to each of the categories.

According to the present disclosure, disclosed is a computer or processor implemented method and system which allows the user to send at least one search term or a search query from the user computing device or other electronic device to the server. The server is adapted to receive at least one search term from the user computing device or other electronic device and identify at least one category and at least one product/service/information and the like, relevant to the search term. Thereafter, the method is adapted to access a plurality of pre-determined weightage attributes and a plurality of ranking attributes either from the server, where they are pre-stored, or from the user computing device, or other electronic device.

The method is further adapted to determine at least one weightage level for at least one category and at least one ranking level for at least one product/service, etc. Further, the method is adapted to sort at least one category and at least one product/service, etc., wherein the sorting is based on the said determined weightage level or the said determined ranking level.

After sorting, the method is adapted to display said sorted results in at least one category and at least one product result/service result, etc., to the user through the user computing device/electronic device.

Accordingly, the processor implementable method and system as disclosed herein solves a definite technical problem in the computing and data processing space.

This together with the other aspects of the present disclosure along with the various features of novelty characterized in the present disclosure are pointed out with particularity in claims annexed hereto and form a part of the present disclosure. For better understanding of the present disclosure, its operating advantages, and the specified objective attained by its uses, reference should be made to the accompanying descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1 represents a framework of searching and ranking the desired categories and products, services, etc. by the processor implementable method, according to an embodiment of the present disclosure;

FIG. 2 represents an illustration of an algorithm as a flowchart for searching and listing various product categories by the processor implementable method, according to an embodiment of the present disclosure;

FIG. 3 represents an illustration of an algorithm as a flowchart for searching and listing various products by the processor implementable method, according to an embodiment of the present disclosure;

FIG. 4 represents an illustration of an algorithm as a block diagram for searching and listing product categories along with searching and listing products, according to an embodiment of the present disclosure;

FIG. 5 represents an illustration of an algorithm as a block diagram for presenting the product categories along with the product to the user by the processor implementable method, according to an embodiment of the present disclosure; and

FIG. 6 represents an illustration of an algorithm as a flowchart for searching a product by the processor implementable method, a according to an embodiment of the present disclosure.

FIG. 7 illustrates an algorithm as a flowchart of an exemplary end to end method for the present disclosure of identifying a product for a user.

Like numerals refer to like elements throughout the present disclosure.

### DETAILED DESCRIPTION OF THE DISCLOSURE

The foregoing description of specific embodiments of the present disclosure has been presented for purposes of illustration and description. It is not intended to be exhaustive or to limit the disclosure to the precise forms disclosed, and obviously many modifications and variations are possible in light of the above. The exemplary embodiment was chosen and described in order to best explain the principles of the disclosure and its practical application, to thereby enable others skilled in the art to best utilize the disclosure and various embodiments with various modifications as are suited to the particular use contemplated.

The terms ‘item’ or ‘product’ do not denote a limitation to physical goods, machine, services or its equivalent; but rather denote any accruable, tradable, transferrable financial and non-financial instrument, object or record.

The term “identifying a product” should not be construed to only identification of products but it further includes identification of services and/or information.

The terms “a” and “an” herein do not denote a limitation of quantity, but rather denote the presence of at least one of the referenced item.

The terms “having”, “comprising”, “including”, and variations thereof signify the presence of a component.

The present disclosure discloses a computer implementable searching method which could be employed on ecommerce websites, such as Amazon.com, Staples.com, ebay.com, Linkedin.com and the like. The computer implementable method is capable of providing filtered, ranked and relevant results (categories or products) in response to a user's search query.

The disclosure includes the following methods among others, a computer implemented method in a plug-in or in-built search interface or API for a website or mobile application, but may not be limited to the methods listed here. The computer implementable method is adapted to receive a search query from the user or from a computer, an electronic device, etc., and provide results for the search query accordingly. It will be apparent to a person skilled in the art that the term ‘search interface’ as used herein refers to an arrangement of various methods in a specific configuration so as to enable transfer of search result, data or any other content between a user(s) at one end and a server/servers at another end or between an electronic device at one end and a server/servers at another end.

Further, though the disclosure is explained with reference to providing desired categories and products (also interchangeably referred as “categories” and “products”) according to various embodiments of the present disclosure, it should not be construed as a limitation to the present disclosure. Accordingly, the various embodiments of the present disclosure may be applicable for providing information on desired songs, audios, videos, contact of a person, and the like, using the teachings disclosed in the present disclosure.

According to one aspect of the present disclosure, a computer implemented method for performing an efficient searching over online retailing platforms on the internet without use of menus or filters is provided. The present disclosure includes a user interface and a server connected via a communication network at the remote end. The user interface includes a query box or a search box configured to accept entry of search query terms as provided by the user. The server receives one or more search query terms from the user interface via a communication network. Thereafter, the remote server automatically executes a search technique based on one or more search query terms. The computer implemented method works as an analyzer and it can be implemented on either of the server end or the user end.

In various embodiments, the computer implemented method is adapted to provide a weightage level and a ranking level to each search result and prioritize or sort the search results based on the weightage level and ranking level. Thereafter, the sorted search results are displayed to the user on the user interface.

It will be recognized that the disclosure may be implemented on any computational devices such as, computing devices, computers, laptops, handhelds communication devices, personal digital assistants (PDAs), mobile phones, consumer electronics devices, embedded devices, and other similar devices having computational capacity. However, such examples should not be construed as a limitation of the present disclosure.

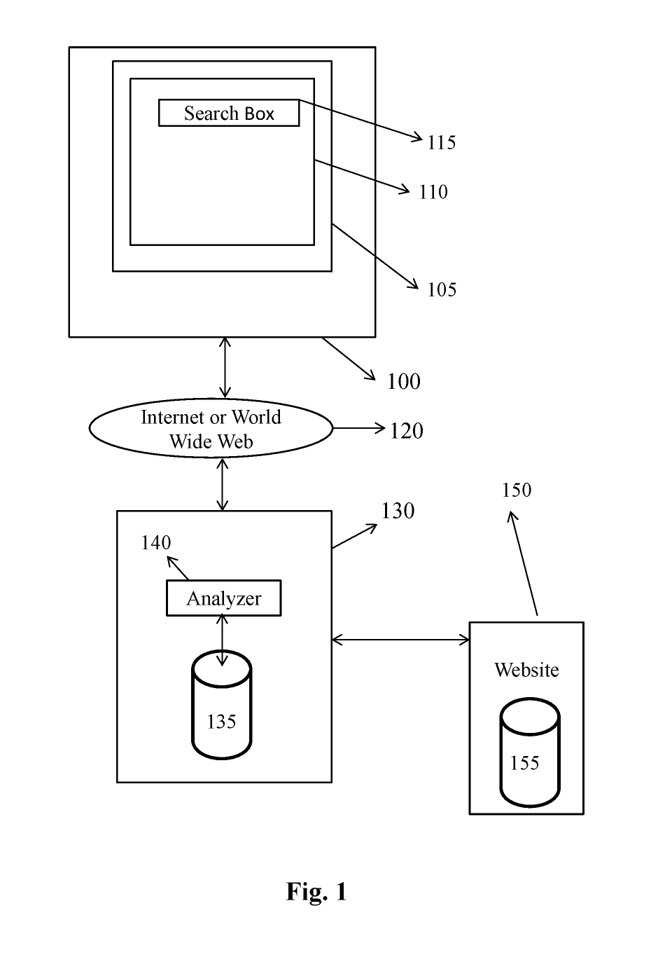

FIGS. 1-6 describes the novel and inventive aspects related to the processor implemented method of the present disclosure.

Now referring to FIG. 1, there is shown a block diagram of one exemplary embodiment of the processor implemented method of the present disclosure. There is shown that a user computing device 100 is connected with a server 130 via an internet platform 120.

In an embodiment, the user computing device 100 includes a graphical user interface 105 having a search plugin 110, wherein, the search plugin 110 further includes a search box 115. The user computing device 100 is connected to a remote server 130 via an internet platform 120.

In various aspects of the present disclosure, the processor implemented method for identifying a product or service or information is in the form of a plugin 110 or a dedicated application 110 for computing devices or a search engine.

The search box 115 is adapted to receive a search term from a user. In an aspect, the search term is at least one of text, a word, a numeric, an alphanumeric, a symbol, a special character, an image, an audio input, a video input, and a combination thereof.

As illustrated in FIG. 1, the remote server 130 connects the user computing device 100 with a desired ecommerce website 150 having a database 155 with a plurality of categories and a plurality of products pre-stored therein. The desired website as disclosed herein may be an ecommerce website for selling products and/or services, such as Amazon.com, Staples.com, eBay.com, and the like.

After the user enters a search term in the search box 115 of the search plugin 110, the user computing device 100 accesses the desired website 150 based on the search term as entered by the user over the search box 115. Further, the remote server 130 responds to the search term by providing most preferred search results from the requested website content over the user computing device 100.

In one embodiment of the present disclosure, the server 130 includes an analyzer 140 and an attribute database 135 which contains a plurality of weightage and ranking attributes, which may be pre-generated and pre-stored therein or which may be generated instantaneously when required. These weightage and ranking attributes are as described below.

In a preferred embodiment, the analyzer 140 is adapted to access a plurality of weightage attributes and a plurality of ranking attributes corresponding to the search term entered by the user. As described above, the said plurality of weightage attributes and plurality of ranking attributes are retrieved from the attribute database 135 or are generated then and there and then stored in the attribute database 135.

The analyzer 140 thereafter determines at least one weightage level for the search term and at least one category based on the plurality of weightage attributes. The analyzer 140 further determines at least one ranking level for the search term and at least one desired product based on the plurality of ranking attributes.

Thereafter, the analyzer 140 sorts the results in at least one category and in at least one product, wherein the said sorting is based on at least one of said determined weightage level and the said determined ranking level. Thus, the analyzer 140 identifies at least one desired category and at least one desired product corresponding to the search term. Then the analyzer 140 transmits such information to the server 130, and server 130 communicates with the user computing device 100. Finally, the user computing device 100 displays said sorted desired category and desired product to the user.

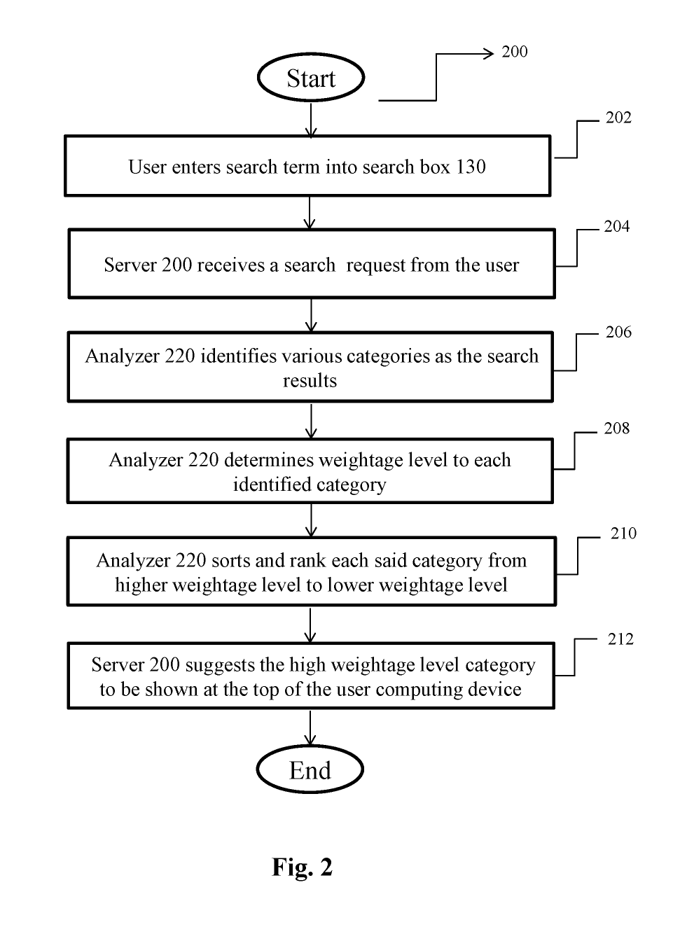

Now referring to FIGS. 2-4, which illustrate algorithms as flow diagrams and block diagrams for computer implemented methods of searching and listing various categories and products corresponding to the search term of the user.

FIG. 2 illustrates an algorithm as a simplistic flow chart of the computer implemented method to identify a category of a product over an online ecommerce platform through the user computing device 100 and the server 130.

As shown in FIG. 2, initially at step 202, the user enters a search term in the search box 115 of the search plugin 110 as appearing on the graphical user interface 105 of the user computing device 100.

At step 204, the server 130 receives the said search term from the user computing device 100 via the internet platform 120. The said search term can be a text, a word, a numeric, an alphanumeric, a symbol, a special character, an image, an audio input, and a combination thereof.

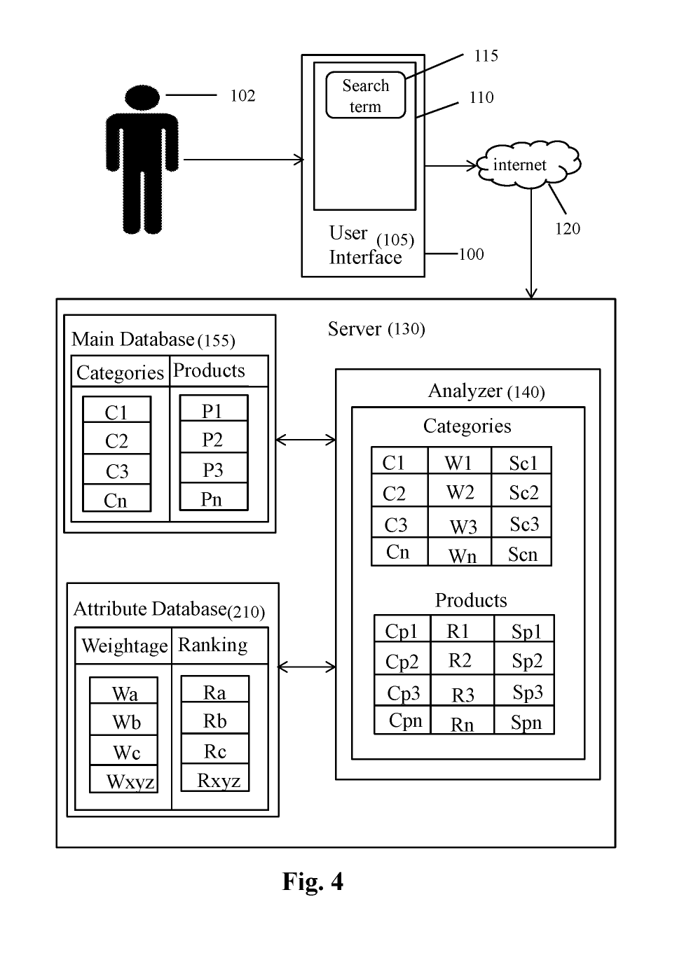

At step 206, the analyzer 140 identifies various categories as the search result from the main database 155. The said identified categories correspond to the search term as entered by the user. At step 208, the analyzer 140 determines a weightage level to each of the said identified categories. The said weightage level depends upon the number of plurality of weightage attributes corresponding to each category. The weightage level allocation is better understood with reference to FIG. 4.

As shown in FIG. 4, which illustrates an algorithm as a block diagram, the user 102 inputs a search term over the search box 115 of the user computing device 100. Then the same search term lands over the server 130. The analyzer 140 determines a weight level (W1, W2, W3 . . . WN) corresponding to each of the categories (C1, C2, C3 . . . CN). The said weightage level (W1, W2, W3 . . . WN) is based on number of plurality of weightage attributes (WA, WB, WC . . . WZ) associated with each category.

Further, the weightage level (W1, W2, W3 . . . WN) for each of the categories is determined by combining all the weightage attributes (WA, WB, WC . . . WZ) associated with that category. Accordingly, a weightage score (SC1, SC2, SC3 . . . SCN) is assigned to each category (C1, C2, C3 . . . CN). Wherein, the said weightage score depends upon the number of weightage attributes associated with that category. The processor implemented method allocates a higher weightage score to a category which is given higher weightage level and a lower weightage score to a category having lower weightage score.

The said plurality of weightage attributes for category determination are selected from a host of factors when and where available including but not limited to the user's preferences, third party preferences, the category characteristics, such as the category history, the category popularity, the category ranking, and the like, the user's geo location, the user's search history, the user's demographics and psychographic details, the user's purchase habits and history, the time of day, the season of the year, the month of the year, the user's friends history and preferences when and where available through social networks and the like, environmental factors like the prevalence of allergy season in the user's geo location, local factors like a national holiday in the user's geo location, the type of device the user is conducting the search on, the search history, purchase habits, purchase history, etc., of people who match the demographic and psychographic profile of the user, and the like.

In an embodiment, the user preferences are retrieved from the user computing device 100 via the internet platform 120. The user preferences are selected from the previous search history of the user over the user computing device 100. The previous search history may include various factors such as, but not limited to, keywords used by the user, various products liked, various products selected, various products purchased, various services liked, various services selected, and/or various services purchased over the website 150.

In various embodiments, the said plurality of weightage attributes is based on the following conditions and information:
i. If the search term exists in a single category, then the products from that category are displayed as there are no matching products in any other category;
ii. same category is given a higher weightage attribute over other categories;
iii. If the search term exists in multiple categories, then a higher weightage attribute is given to categories which have the maximum number of mentions/items of the search term;
iv. If the user simply enters the category name in the search term, say “book harry potter” then the search term “book”, is first treated as a category name and given higher weightage.
v. By tracking users browsing history, such as keeping track of website sections or categories the user frequently visits and by using a multitude of other factors such as those mentioned in the preceding paragraphs above, like environmental factors, etc. For example, if a particular user visits amazon.com and often searches and selects movies and books, then these could be called the user's favorite categories. These user's favorite categories are given higher weightage. In addition to this there could be categories which the user has never visited; results from these never visited categories are given lower weightage.
vi. By tracking user browsing history, such as keeping track of user's last search event for the same search term and categories browsed by the user. For example, by giving higher weightage to the maximum number of times each category is browsed, giving a lower weightage to the category which has never been browsed, unless other factors overwhelmingly show that the user may be trying to search within a new category;
vii. By tracking the gender of the user e.g. a man may be more likely to look for electronics category and a woman may be more likely to look for beauty category;
viii. By tracking the users' geographical location, such as if the same search term is entered from the same geographical location and a particular category is selected then such category is given higher weightage over other categories;
ix. By tracking other users' browsing history, calculating how many items in a particular category have been sold/reviewed or recently browsed x. By other users vis-a-vis the other matching categories and where a substantial difference is found, the category which is more ‘active’ is given higher weightage attribute;
xi. By tracking other users browsing history, such as keeping track of the other users' last search event for the same search term and categories browsed by other users. For example, by giving higher weightage to the maximum number of times each category is browsed, giving lower weightage to the category which has never been browsed;
xii. By tracking the category history, by keeping track of events when the matching item in each category was last updated, and/or reviewed;
xiii. By giving weightage to the highest and lowest selling brands, the category having higher selling brands is given higher weightage;
xiv. By giving weightage to the freshness of the listing of each category, the category which is updated recently is given higher weightage;
xv. By giving higher weightage to categories which have an ongoing or upcoming promotion or discounted products;
xvi. By giving weightage to the users' preferences such as brands, size, color, actors, authors etc. The category having such user preferences are given higher weightage e.g. the user has bought products earlier like say a shirt in a size medium size or shoes in size 7; then categories having such size and color are given higher weightage;
xvii. Based on whether a category having the item with free shipping, if the item is available for shipping to the users zip code/country, then such category is given higher weightage;
xviii. By giving weightage to the user's preferences such as the languages the user prefers in books, movies and other similar search items;
xix. By giving weightage to the user's preferences such as whether the user prefers used or new items, if the user prefers new items then the category with new item is given higher weightage;
xx. Based on whether the user prefers a particular format like e-book, hardback, collector version, CD, Vinyl, mp3 and other similar formats.

Now again referring to FIG. 2, at step 210, the analyzer 140 sorts and ranks each of the category from high weightage level to low weightage level.

Hence, the analyzer 140 identifies at least one category corresponding to the user's preferences and the search term as provided by the user or provided by another computing device/electronic device, etc. Accordingly, at step 212, the server 130 communicates with the user computing device 100 and the category having higher weightage level is shown on the top of the search results.

In one embodiment of the present disclosure, the analyzer 140 as disclosed in the present computer implemented method provides high priority to the search results having category with high weightage level and having product with high ranking level. Thereafter, the search results as per their priority are shown to the user 102 on the graphical user interface 105 of the user computing device 100.

In another embodiment, the search results are provided to the user as an audio output. For example, when the user searches for a “hair dryer” on the computing device with an audio input search query, the present system and method presents the ranked results in audio output while displaying them. In another example the results are presented only via audio output.

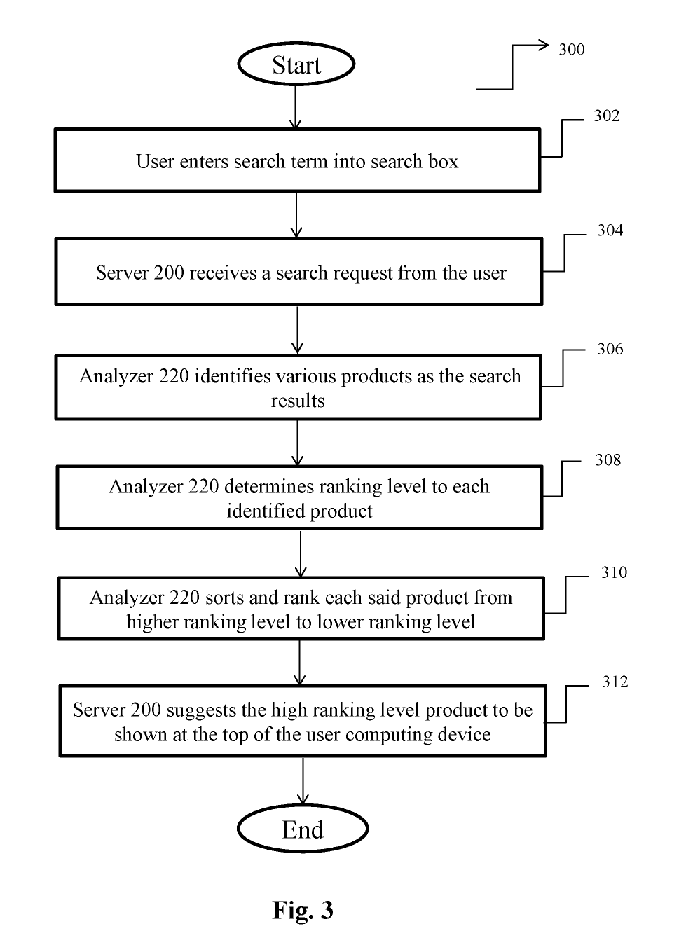

Now referring to FIG. 3, which illustrates an algorithm as a simplistic flow chart of the computer implemented method to identify a product over an online ecommerce platform through the user computing device 100 and the server 130.

As shown in FIG. 3, the processor implemented method 300 starts at step 302, the user enters a search term in the search box 115 of the search plugin 110 as appearing on the graphical user interface 105 of the user computing device 100. At step 304, the server 130 receives the said search term from the user computing device 100 via the internet platform 120. At step 306, the analyzer 140 identifies various products as the search results from the main database 155. The said identified products correspond to the search term as entered by the user.

At step 308, the analyzer 140 determines a ranking level to each of the said identified product. The said ranking level depends upon the number of plurality of ranking attributes corresponding to each product. Thus, some implementations improve the field of human and computer interaction because the method provides the best/most relevant results at the top of the displayed results.

For example, as shown in FIG. 4, the user 102 inputs a search term over the search box 115 of the user computing device 100. Then the same search term lands over the server 130. Now, the analyzer 140 determines a ranking level (R1, R2, R3 . . . RN) corresponding to each of the category (P1, P2, P3 . . . PN). The said ranking level (R1, R2, R3 . . . RN) is based on number of plurality of ranking attributes (Ra, Rb, Rc . . . Rz) associated with each product. The said plurality of ranking attributes is either selected from the user preferences, third party preferences, or the product history.

Further, the weightage level (W1, W2, W3 . . . WN) for each of the category is determined by combining all the weightage attributes (Wa, Wb, Wc . . . Wz) associated with that category. Accordingly, a weightage score (SC1, SC 2, SC 3 . . . SC N) is assigned to each category (C1, C2, C3 . . . CN). Wherein, the said weightage score depends upon the number of weightage attributes associated with that category. A category with higher weightage score is given higher weightage level and a category having lower weightage score is given lower weightage level.

Now again referring to FIG. 3, at step 310, the analyzer 140 sorts and ranks each product from high ranking level to low ranking level. Hence, the analyzer 140 identifies at least one product corresponding to the user preferences and the search term as provided by the user. Accordingly, at step 312, the server 130 communicates with the user computing device 100 and the product having higher weightage level is shown on the top of the search results.

In various embodiments, the said plurality of ranking attributes is based on the following conditions and information:
i. by keeping track of the number of highest selling items of the given product. For example, a search for iPhone 5 may show that the iPhone 5 itself is the highest selling product as compared to the iPhone 4 or the iPhone 6, and thus give the iPhone 5 a higher ranking;
ii. by keeping track of choice of other users, when they click on an item on the results presented to the user while they search for the same term e.g. search term iPhone 5 gives many results and most of the users only click on the iPhone 5 phone result itself, rather than on the charging device for the iPhone 5 and/or on accessories for the iPhone 5. Higher searched, browsed and purchased products are given higher ranking;
iii. by keeping track of the rating given by different users such as from one star to five stars and may show the results from five and four stars over those of one and two star. Higher rated products are given higher ranking;
iv. by keeping track of the number of user ratings that each product has received from the user itself. A product higher rated by the user itself is given with higher ranking;
v. by keeping the track record of interests of user by means of cookies, the history of the user on the given website and on the other websites and which type of items the user has browsed in the past from the set of results. For example, has the user browsed in the past for the iPhone 5 accessories cable for iPhone 5 or iPhone 5. The product browsed by the user in the past is given higher ranking;
vi. by keeping track record for the new products and out of stock products. The newer products are given with higher ranking value over the out of stock products;
vii. by keeping the track record of the shipments. Products and items which are frequently shipped to the user's country or zip code are given higher ranking over the products and items having lower number of shipments to the user's country: or no shipment;
viii. by keeping the track record of whether the user selects and purchases the higher end products in terms of price or the lower end products and ranks the results accordingly;
ix. by keeping track record of various factors like size, capacity, color of the specific product and the item, brand preference of the user in various previous searches and accordingly give ranking for the search results; and
x. by keeping track record of the preference of other users from the same zip code or state or country as a criterion for ranking the search results.

In an embodiment, the method of the present disclosure further gives a higher ranking to the products or items selection which are close to the products or the item selection that matches the user past history. For example, if the user has bought or downloaded a movie whose director is Steven Spielberg and whose main cast includes “Liam Neeson” and whose genre is historical, then the next time when the user searches for movies, the method may give these factors as higher rating for ranking the search results. Thus, in some implementations, the present computer implemented method improves the field of human and computer interaction, because the method provides better understanding of the users' search query and provides automatic filtered results without using menus or filters.

In another embodiment, the method of the present disclosure gives higher ranking to similar products previously purchased by the user.

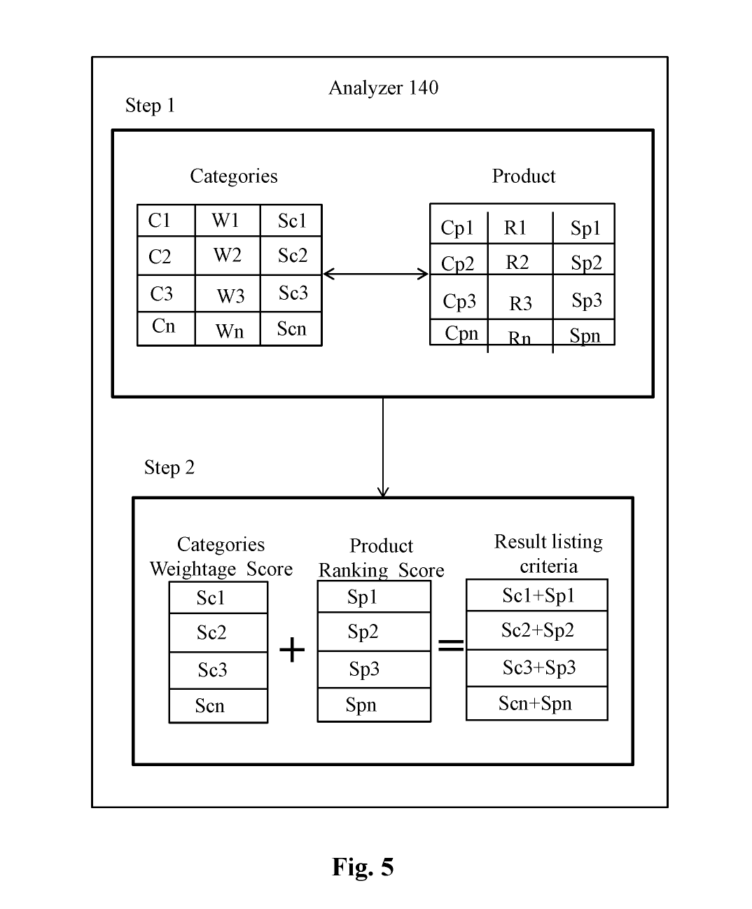

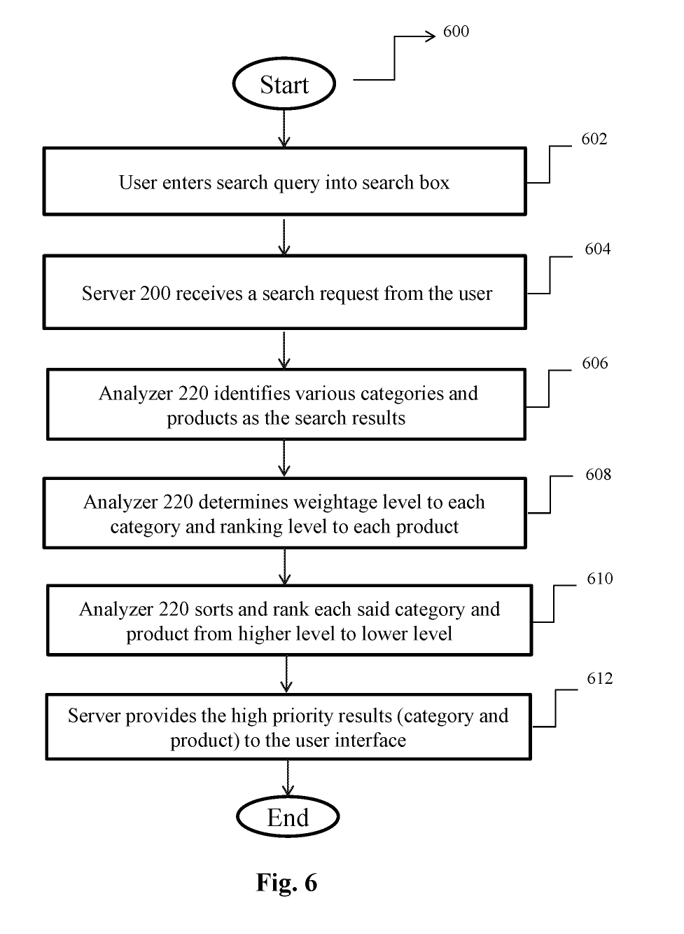

FIG. 5 and FIG. 6 illustrate algorithms as a block diagram and a flow diagram for presenting the product categories along with the product to the user over the graphical user interface 105 of the user computing device 100.

As shown in FIG. 6, at step 602, the user enters a search term into the search box of the user computing device 100. At step 604, the server 130 receives at least one search term from a user computing device 100 via internet platform 120. At step 606, the analyzer 140 identifies various categories and various products as the search result from the main database 155. The said identified categories and products correspond to the search term as entered by the user.

Thereafter, at step 608, the analyzer 140 determines a weightage level to each of the said identified category and a ranking level to each of the identified product. The said weightage level depends upon the number of plurality of weightage attributes corresponding to each category. The said ranking level depends upon the number of plurality of ranking attributes corresponding to each category.

For example, as shown in FIG. 5, at step 1, the categories (C1, C2, C3 . . . CN) are shown along with their weightage level (W1, W2, W3 . . . WN). The weightage level as provided herein depends upon the weightage score (SC1, SC2, SC3 . . . SC N) of the category. The weightage score for each of the category is obtained by combining the number of weightage attributes associated with that category.

Further, at step 1, the products (P1, P2, P3 . . . PN) are shown along with their ranking level (R1, R2, R3 . . . RN). The ranking level as provided herein depends upon the ranking score (SP1, SP2, SP3 . . . SPN) of the product. The ranking score for each of the product is obtained by combining the number of ranking attributes associated with that product.

At step 2, the category having higher weightage score is combined with the product having higher ranking score. Accordingly, the category and the product having higher weightage and ranking score are displayed on the top of the search results. Further, the category and the product having lower weightage and ranking score are displayed on the bottom of the search results.

Now referring to FIG. 6, at step 610, the analyzer 140 sorts the categories as well as the products from higher priority to lower priority order. At step 612, the server 130 provides the high priority category and product as a search result to the user through the graphical user interface 105 of the user computing device 100. Accordingly, the method as disclosed in the present disclosure is adapted to automatically identifying a desired product for a user over an online platform. Thus, in some implementations, the present computer implemented method provides improves the field of human and computer interaction, because the method provides better understanding of the users' search query and provides automatic filtered results without using menus or filters. Additionally, in some implementations, the present computer implemented method improves the field of human and computer interaction, because the method removes the dependencies on menus/multiple fields/multiple controls in order to facilitate easier search and improves search result representation to the user on various web sites in the computing world.

In another embodiment of the present disclosure, the remote server 130 makes a contact with the user's device 100. Thereafter, the server 130 fetches the user preferences from the user device 100. In another embodiment of the present disclosure, the remote server 130 makes a contact with the third party computing devices. Thereafter, the server 130 fetches the third party preferences from such third party computing devices.

In various embodiments, the weightage attributes and ranking attributes respectively corresponding to the categories and products are provided by the server 130 to the analyzer 140.

In an exemplary embodiment, on a site like ebay.com™, the user first has to choose the category, and then may need to choose various filters like size, price, style, brand, color etc. The present disclosure proposes a simpler method where the results are displayed directly without using the dropdown menus and filters, and solves a particular technical problem prevalent in data processing fields. Thus, in some implementations, the present computer implemented method improves the field of human and computer interaction, because the method provides better understanding of the users' search query and provides automatic filtered results without using menus or filters.

Accordingly, the present disclosure provides a very simple and user friendly system and method of searching through the menus without necessarily having to select the type of items, then further distilling down on the brand, size, specify color, price, composition and various other filtering criteria of the product or the search item. Thus, in some implementations, the present computer implemented method improves the field of human and computer interaction, because the method provides a better ranking methodology in order to provide the best/most relevant results at the top of the displayed results.

The present disclosure proposes a method of automatically trying to understand the user's input of the search query and then ranking the results according to the user's input. Further, the present disclosure provides a system and method where the user's input is not limited to the simple keywords and it can be extended to images, video, audios or any other type of input criteria.

In an exemplary embodiment, the present disclosure remembers user details and provides the results for the search accordingly. For example, when the user types “Pepe Jeans”, the present method presents the ranked results with “Pepe Jeans for men” with “dark blue” color and waist size of “32”. This gathers from the fact that method remembers that user is a male (from account name, browsing items etc.) who opts for 32 inch dark blue jeans every time (from user history). Hence, the present disclosure narrows down the search results for the user which he would have done eventually in absence of present disclosure.

Similarly in the example of a social networking site like say LinkedIn, the user has to specify whether he/she is looking for a person, a company, a particular person, etc. Here the processor implemented method disclosed herein would use the same weightage and ranking criteria as outlined hereinabove in the example given of ecommerce websites such as Amazon, eBay, and the like. While implementing this method on the social networking websites, the weightage and ranking levels will depend on factors including but not limited to the following such as whether the user shares a common interest, industry, company, location, friends, and the like with the other persons.

As per an example, a user whose interests include software and searches for the term “Dave” and the system of the present disclosure looks for the term “Dave” in the software category and finds the company called “Dave Software”. Further, the method of the present disclosure would use information when and where available from the user's profile and from the users' first and second degree contacts. The information would include but not be limited to:
i. demographic and psychographic details;
ii. general and specific interests and hobbies;
iii. the groups and other networks he/she/they are associated with;
iv. the number of friends they have on the social network;
v. their geo location;
vi. their past history;
vii. their employment history;
viii. the geographical locations they have lived in; and
ix. biodata.

Accordingly, the method of the present disclosure ascertains the context of the search term. In one embodiment, the context may be determined based on the teachings disclosed in U.S. Pat. No. 8,745,045 from the same inventors.

It is most likely that the number of results will be very high and the user has to make a selection from the filters presented on the user interface to find out the desired result. If these criterions are manually selected then sometimes the final result does not match with the user's requirements.

In an exemplary embodiment the method of the present disclosure may further use following ranking criteria: a) number of connections of the person on the website; b) number of years spent in each job; c) how much the user role has been changed over time; d) seniority of the person and other similar criteria for ranking the search results. The method of the present disclosure may also look at how the user's company is performing through the use of published ranking of companies by sale, location, best employers, awards, number of people working in the company etc., this ranking criteria is helpful for the human resource department of the company.

In an embodiment, the present disclosure is a plugin installed on product website. The plugin performs a search automatically without the user input. For example, the user purchases “Digital Camera” and switches over to other applications on his computing device. The plugin still runs in the background identifying potential items that would go with the newly purchased camera, such as, “Memory Card”, “rechargeable battery”, “camera pouch”, etc. After this background search is completed, the user is notified by a pop-up message regarding the items he would most likely buy in the future for his newly purchased camera.

In an exemplary embodiment the method of the present disclosure also provides a user friendly method for ranking the content of an audio website and/or a video website such as YouTube™. The ranking criteria and filtering of the search results is based on various factors including the following but not limited to:
i. number of views of the video;
ii. date of the video;
iii. length of the video compared to the other videos in the search results;
iv. number of recent views;
v. date on which the video was uploaded;
vi. based on the users internet connection the method may rank a video which is in HD format higher than the same video whose video quality is not of HD quality;
vii. separate the results on those which are interviews, documentaries and the like by using the title of the videos;
viii. which videos the user has given a thumbs up or thumbs down;
ix. what is the ratio of total number of thumbs up vs thumbs down;
x. whether the user has shared the video with other users;
xi. how many comments the video has received and the date of the comments;
xii. the method may also use an existing database which has linkages of people product etc., for example, if the user has browsed for videos on the television show “Seinfeld” then the method may look in existing database on television shows most similar to “Seinfeld” like and suggest those shows to the user; and
xiii. The method may also try and match users who have the most common number of videos/topics browsed, to suggest videos to users which have been browsed by the users counterpart(s)′. This profile can be made using the aforesaid and may also include, geography based on users IP, number of videos which match exactly or partially, number of topics which match partially or exactly;

In an exemplary embodiment the processor implemented method of the present disclosure also provides a user friendly automatic ranking method for website applications like for example say Apple's iTunes™. The ranking criteria and filtering of the search results includes but is not limited to the following factors:
i. the method ranks the tracks based on the number of times the track has been played;
ii. the method ranks the tracks based on the rating of the tracks. The method may use ratings of a track made by other users;
iii. the method would record which tracks are played more often during which time of the day and accordingly may suggest tracks to the user or play a series of tracks automatically for the user;
iv. there are many songs which are different versions of the same song, played by the same artist on different albums. For example a track like “Stairway to Heaven” by the band Led Zeppelin or “Money” by band Pink Floyd may have multiple versions. Whenever, the user searches for the track, the method may show the version of the song which has been played the maximum number of times at the top of the results
v. on many occasions, users want to listen to a portion of a song, like a guitar piece in the middle of the song repeatedly, or portions of a song, like say the first half of the song. The method can keep a track of said pieces of songs so that the user can listen to a number of songs in a short period of time;
vi. similarly the user may have a preference for a version of a song which has an extended track, which may run for say 10.06 minutes versus another version which runs for 8.01 minutes. Whenever, a user searches for a track, the method may use this as well as the number of times a track has been played to rank and display the top results; and
vii. the method may also auto suggest tracks based on the first couple of tracks that the user has selected in a ‘new session’ while using iTunes or an equivalent application on any device, provided that the first and seconds track are not part of the same album and are not sequentially placed in the album.

This is done to understand the mood of the user and automatically suggest and/or play tracks by trying to understand the mood of the user. For example, a user may be in a mood to listen to rock, or the user may be in a mood to listen to instrumental music, or solo tracks.

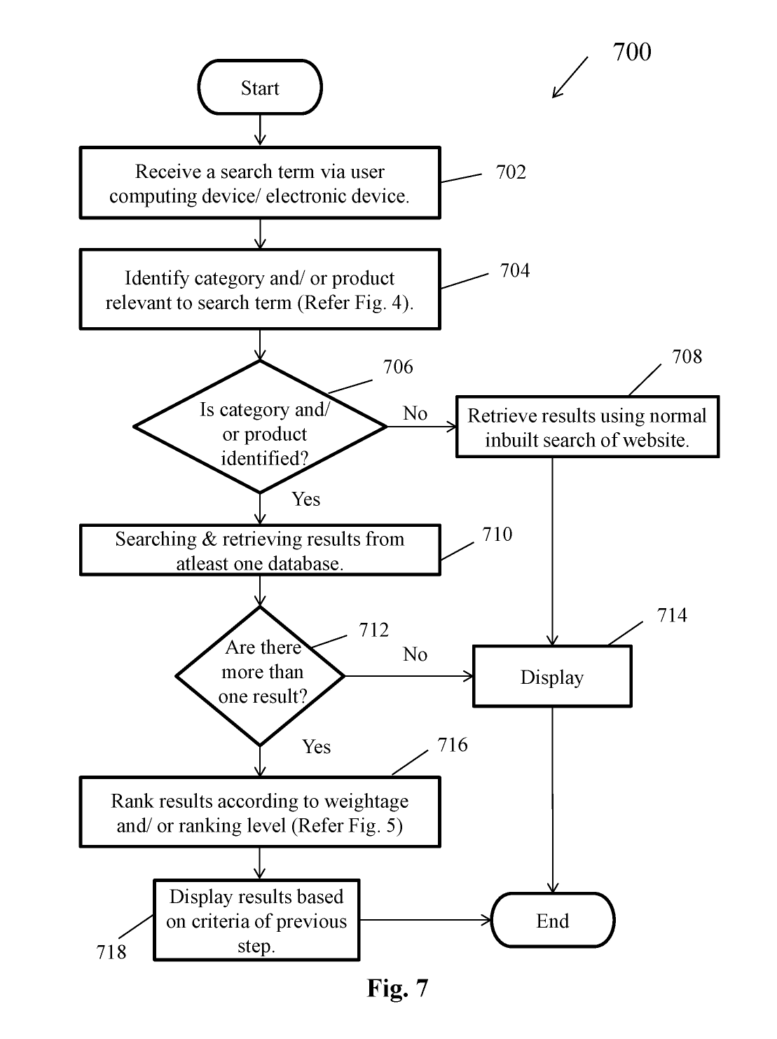

As illustrated in FIG. 7, which illustrates an algorithm as a flowchart, an exemplary end to end method for the present disclosure of identifying a product for a user is presented. The method 700 begins at 702 where a search term is received by the server via user computing device or any other electronic device. As disclosed earlier, the search term can be input in form of text, multimedia (image, audio, and video), gestures and the like.

The next step 704, server identifies category and/or product relevant to the search term (as disclosed in the description of FIG. 4). The next step 706, server determines if the search term belongs to any of the category and/or product in the attribute database. If not, the method proceeds to step 708 where the results corresponding to the search term are retrieved using normal inbuilt search of the website. If the category and/or product is identified at step 706, the method moves to 710. At the step 710, the server will retrieve results from the main database of the website based on the said identified category and/or product.

The step 712, the method 700 determines the number of results retrieved. If the results are more than one (1), then at step 716, they are ranked according to weightage and/or ranking level (as disclosed in description of FIG. 5). After the results are ranked, at step 718 the ranked results are displayed. If at step 712, there is only one result then it is directly displayed at step 714. The method ends thereafter. Thus, in some implementations, the present computer implemented method improves the field of human and computer interaction, because the method removes the dependencies on menus/multiple fields/multiple controls in order to facilitate easier search and improves search result representation to the user on various web sites in the computing world.

The method thus improves the field of human-computer interaction by presenting the most preferred tracks to the user without any manual intervention by the user.

The above criteria help the user to find out the desired search result without having to use filters and menus.

The method, as described in the disclosed teachings or any of its components, may be embodied in the form of a computer implemented method. Typical examples of a computer included in the computer implemented method include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

In a computer implemented method using a general purpose computer, such a general purpose computer can include an input device such as a keyboard, a mouse, a trackball, a touchpad, a microphone, or a camera. The computer can include a display unit, such as a projector, a monitor, or a touch screen. A touch screen can also be used as an input device. Specifically, the computer of the computer implemented method can comprise a hardware microprocessor, where the microprocessor is connected to a communication bus. The computer of the computer implemented method can also include a memory; the memory can include Random Access Memory (RAM) and Read Only Memory (ROM). The computer of the computer implemented method can further comprise a non-transitory computer readable medium such as a storage device, which can be a hard disk drive or a removable storage drive such as a flash drive, optical disk drive, and the like. The storage device can also comprise other similar means for loading computer programs or other instructions into the computer of the computer implemented method.

The computer of the computer implemented method may comprise a communication device to communicate with a remote computer through a network. The communication device can include a wireless communication port, a data cable connecting the computer of the computer implemented method with the network, or the like. The network can be a Local Area Network (LAN) or a Wide Area Network (WAN) such as the Internet and the like. The remote computer that is connected to the network can be a general-purpose computer, a server, a PDA, and the like. Further, the computer of the computer implemented method can access information from the remote computer through the network.

The algorithms described above can be embodied as sets of instructions stored on the computer readable medium which include various commands that instruct the computer of the computer implemented method to perform specific tasks such as the steps that comprise the methods and algorithms of the disclosed teachings. The sets of instructions may be embodied in the form of a transitory medium, such as a software program or a propagating wave. The software may be in various forms such as method software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs containing the set of instructions embodied therein. The processing of input data by the computer of the computer implemented method may be in response to user commands or in response to the results of previous processing or in response to a request made by another computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient but such omissions and substitutions are intended to cover the application or implementation without departing from the spirit or scope of the present disclosure.

What is claimed is:

1. A computer-implemented method for identifying a product for a user in an online, offline, cloud based, desktop platform comprising a server connected to at least one database having a plurality of categories and a plurality of products corresponding to the plurality of categories, the method comprising:
receiving at least one search term from the user or from an electronic device via a user computing device;
identifying at least one category and at least one product relevant to the search term;
accessing a plurality of weightage attributes and a plurality of ranking attributes corresponding to the inputted search term, wherein the weightage attributes and the ranking attributes are being accessed from the server or the user computing device;
determining at least one weightage level for each of the at least one identified category, wherein the weightage level is determined based on the accessed plurality of weightage attributes;
determining at least one ranking level for each of the at least one identified product, wherein the at least one ranking level is determined based on the accessed plurality of ranking attributes;
sorting the at least one identified category based on the determined weightage level;
sorting the at least one identified product based on the determined ranking level;
ranking the results based on various pre-determined criteria; and
displaying said ranked results in at least one category and said sorted results in at least one product to the user through the user computing device.

2. The computer-implemented method as claimed in claim 1, wherein the search term comprises at least one of text, a word, a numeric, an alphanumeric, a symbol, a special character, an image, an audio input, a video input, and a combination thereof.

3. The computer-implemented method as claimed in claim 1, wherein the user computing device comprises at least one of a Personal Digital Assistant (PDA), a mobile phone, a laptop, a computer, a smartphone, a smartwatch or communication device with user interface.

4. The computer-implemented method as claimed in claim 1, wherein the server pre-stores the plurality of weightage attributes and the plurality of ranking attributes in at least one database.

5. The computer-implemented method as claimed in claim 1, wherein the server is adapted to retrieve the plurality of weightage attributes and the plurality of ranking attributes from the users computing device.

6. The computer-implemented method as claimed in claim 1, wherein the weightage level for each of the at least one category is determined by comparing maximum number of the plurality of weightage attributes associated with the each of the at least one category.

7. The computer-implemented method as claimed in claim 6, wherein the plurality of weightage attributes for category determination are determined based on user's browsing history, user preferences, third party preferences, and category characteristics.

8. The computer-implemented method as claimed in claim 7, wherein sorting the at least one category comprises arranging the at least one category which has highest weightage level.

9. The computer-implemented method as claimed in claim 1, wherein the plurality of ranking attributes are pre-determined and pre stored based on one or more product parameters.

10. The computer-implemented method as claimed in claim 1, wherein sorting the at least one product comprises arranging the at least one product which has maximum number of the ranking attributes first.

11. The computer-implemented method as claimed in claim 11, wherein the said plurality of ranking attributes are determined based on user's browsing history, and user preferences.
